(19) United States
(12) Patent Application Publication
(10) Pub. No.: US 2007/0280090 A1
(43) Pub. Date: Dec. 6, 2007

(54) Optical pickup device and optical disc apparatus

(75) Inventor: Takahiro Miyagi, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/786,673

(22) Filed: Apr. 12, 2007

(30) Foreign Application Priority Data
Apr. 21, 2006 (JP) JP2006-118318
Dec. 6, 2006 (JP) JP2006-329757

(51) Int. Cl. G11B 21/16

(52) U.S. Cl. 369/244.1

(57) ABSTRACT

An optical pickup device includes a lens holder having an objective lens focusing a light beam onto a signal recording surface of a rotated optical disc and being movable in a focusing direction in parallel with the optical axis of the objective lens and in a tracking direction perpendicular to the optical axis of the objective lens; a support body supporting the lens holder movably in the focusing direction and the tracking direction; and an elastic support member supporting the support body to a base and including a pair of support legs that are inclined to expand the space between the support legs from one ends supporting the support body toward the other and include a plurality of support pieces formed from the one ends toward the other. The support pieces are formed by forming roughly circular, roughly elliptic, or roughly rectangular cut-outs on the support legs.

### CROSS REFERENCES TO RELATED APPLICATIONS

The present invention contains subject matter related to Japanese Patent Application JP 2006-118318 filed in the Japanese Patent Office on Apr. 21, 2006, and Japanese Patent Application JP 2006-329757 filed in the Japanese Patent Office on Dec. 6, 2006, the entire contents of which are incorporated herein by reference.

### BACKGROUND OF THE INVENTION

1. Field of the Invention

The present invention relates to an optical pickup device used for recording or reproducing an information signal to or from an optical disc and an optical disc apparatus using the optical pickup device.

2. Description of the Related Art

As a recording medium of an information signal, an optical disc, such as a CD (compact disc) and a DVD (digital versatile disc), has been used, and for reproducing the information signal recorded on such an optical disc, an optical pickup device has been used.

Such an optical pickup device includes a focusing actuator for moving an objective lens in a focusing direction, which is the optical axial direction, in order to focus a light beam emitted from a light source on a recording surface of an optical disc. Furthermore, the optical pickup device includes a tracking actuator moving the objective lens in a tracking direction on the plane perpendicular to the optical axis for following up a recording track of the optical disc. That is, the optical pickup device has a biaxial actuator for displacing the objective lens in focusing and tracking directions perpendicular to each other.

For having a more accurate circular shape of an optical spot formed on the recording surface of the optical disc with the increase in recording density of the optical disc, there has been proposed an optical pickup device having a tri-axial actuator capable of inclining the optical axis of the objective lens in a tilting direction by following the inclination of the optical disc in addition to displacements in focusing and tracking directions.

An optical pickup device 201 having the biaxial or the tri-axial actuator mentioned above, as shown in FIG. 12, includes a lens holder 202 having a plurality of objective lenses 221 and 222 mounted thereon, a support body 203 for supporting the lens holder 202 via a plurality of support arms 206 movably in the focusing and tracking directions, and an elastic support member 204 for elastically supporting the support body 203 on a base.

In the optical pickup device 201, the lens holder 202 is provided with a focus coil and a tracking coil (both not shown) attached thereto and a magnet (not shown) arranged on a surface opposing these coils, and the focusing and tracking are performed with an electromagnetic force generated by turning on electricity through these coils. Furthermore, when a coil and magnet for tilting is provided, with an electromagnetic force generated by turning on electricity through this coil, the elastic support member 204 is deformed so as to be able to displace the objective lenses in the tilting direction.

The natural frequency of such an optical pickup device herein generally ranges from 2 to 5 kHz, and the disturbance in transfer characteristic due to the natural frequency inhibits the servo-stability. That is, the deterioration in servo-characteristic due to the resonance generation has become a problem.

This is the reason why as shown in FIG. 13, the frequency band Af, used in the servo-control of the optical pickup device for recording/reproducing an information signal on/from the optical disc, ranges about from 1.5 to 40 kHz. Referring to FIG. 13, solid line L1 shows changes in gain (dB) against changes in frequency (Hz); solid line L2 shows changes in phase (deg) against changes in frequency (Hz).

Then, in an optical pickup device in related art, in order to solve the problems described above, the drive forces in focusing and tracking directions are stabilized by adjusting the magnet position for suppressing the natural frequency; however the assembly process and the adjustment process are complicated due to very high accuracy demanded for this adjustment.

### SUMMARY OF THE INVENTION

It is desirable to provide an optical pickup device and an optical disc apparatus having high servo-stability by suppressing natural frequencies without including a complicated adjustment process.

According to an embodiment of the present invention, there is provided an optical pickup device that includes a lens holder having an objective lens focusing a light beam onto a signal recording surface of a rotated optical disc, the lens holder being movable in a focusing direction in parallel with the optical axis of the objective lens and in a tracking direction perpendicular to the optical axis of the objective lens; a support body spaced from the lens holder in a tangential direction perpendicular to the focusing direction and to the tracking direction, the support body supporting the lens holder movably in the focusing direction and the tracking direction; and an elastic support member supporting the support body to a base, in which the elastic support member includes a pair of support legs supporting the support body, the support legs being inclined to expand the space between the support legs from one ends supporting the support body toward the other fixed to the base, and a pair of the support legs respectively include a plurality of support pieces formed from the one ends toward the other and are respectively made of a plate-like member, a plurality of the support pieces being formed by forming roughly circular, roughly elliptic, or roughly rectangular cut-outs on the support legs.

Also, the natural frequency of the elastic support member in modes of natural vibration in a rotational direction about the focusing axis, a rotational direction about the tracking axis, and a rotational direction about a tangential axis perpendicular to the focusing direction and to the tracking direction is larger than the rotation frequency of the optical disc as well as the natural frequency of the elastic support member is to be small to some extent of not impairing the servo-stability when the lens holder is displaced.

An optical disc apparatus according to an embodiment of the present invention includes driving means for rotating an optical disc; and an optical pickup device irradiating the optical disc rotated by the driving means with a light beam so as to record or reproduce an information signal thereon or therefrom, the optical pickup device detecting a light beam reflected from the optical disc, in which the optical pickup device is the same as described above.

According to the embodiment of the present invention, the complicated adjustment for suppressing the natural frequency can be eliminated without deteriorating servo-characteristics, so that the process is simplified and cost is reduced as well as favorable servo-characteristics can be obtained.

### BRIEF DESCRIPTION OF THE DRAWINGS

FIG. 1 is a block circuit diagram of an optical disc apparatus including an optical pickup device according to according to an embodiment of the present invention;

FIG. 2 is a perspective view of the optical pickup device according to the embodiment of the present invention;

FIG. 3 is an exploded perspective view of the optical pickup device according to the embodiment of the present invention;

FIGS. 4A to 4D are drawings showing polarizing patterns of magnets, wherein FIG. 4A includes plan views viewed from lens holders of first and second magnets arranged on a movable side, FIG. 4B is a plan view viewed from a lens holder of a third magnet arranged on a fixed side, FIG. 4C is a plan view viewed from a support body of one tilting magnet, and FIG. 4D is a plan view viewed from a support body of the other tilting magnet;

FIGS. 5A to 5C are drawings of an elastic support member constituting the optical pickup device according to the embodiment of the present invention, wherein FIG. 5A is a perspective view of the elastic support member, FIG. 5B is a front view of the elastic support member, and FIG. 5C is a plan view of one leg piece constituting the elastic support member;

FIGS. 6A and 6B are drawings of another elastic support member constituting the optical pickup device according to the embodiment of the present invention, wherein FIG. 6A is a perspective view of the elastic support member, and FIG. 6B is a plan view of one leg piece constituting the elastic support member;

FIGS. 7A and 7B are drawings of still another elastic support member, wherein FIG. 7A is a plan view of one leg piece having an elliptic cut-out of the elastic support member, and FIG. 7B is a plan view of one leg piece having a plurality of cut-outs;

FIG. 8 is a perspective view of still another elastic support member configured by bending one leaf spring member;

FIGS. 9A to 9C are schematic views showing simulated results of natural frequencies in natural vibration modes of each direction when the elastic support member shown in FIGS. 5A to 5C is incorporated;

FIGS. 10A to 10C are schematic views showing simulated results of natural frequencies in natural vibration modes of each direction when the elastic support member shown in FIGS. 6A and 6B is incorporated;

FIGS. 11A to 11C are schematic views showing simulated results of natural frequencies in natural vibration modes of each direction when the elastic support member shown in FIG. 12 is incorporated as comparative examples for comparing with simulated results of the optical pickup devices according to the embodiment of the present invention shown in FIGS. 9A to 10C;

FIG. 12 is a perspective view of an optical pickup device in a related art; and

FIG. 13 is a graph showing open-loop characteristics of an actuator of a general optical pickup device.

### DESCRIPTION OF THE PREFERRED EMBODIMENTS

An optical disc apparatus incorporating an optical pickup device according to an embodiment of the present invention will be described below with reference to the drawings.

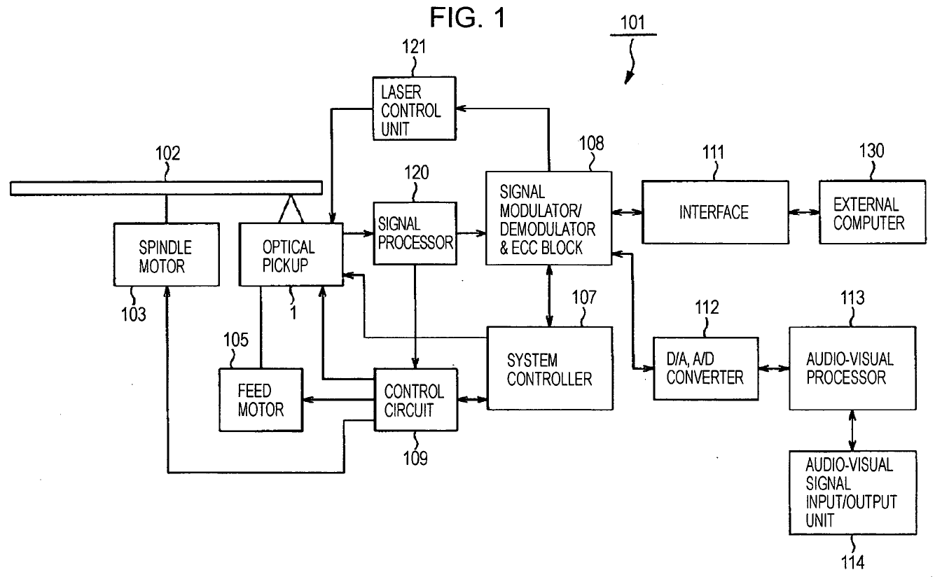

The optical disc apparatus 101 according to the embodiment of the present invention, as shown in FIG. 1, includes a spindle motor 103 for rotating an optical disc 102, such as a CD, a DVD, a CD-R, a DVD±R, and a DVD-RAM, an optical pickup device 1, and a feed motor 105 for moving the optical pickup device 1 in a radial direction. The spindle motor 103 is controlled to have a predetermined number of revolutions by a system controller 107 and a control circuit 109.

A signal modulator/demodulator & ECC block 108 modulates/demodulates a signal outputted from a signal processor 120 and applies an ECC (error correction code) thereto. The optical pickup device 1 irradiates a signal recording surface of the rotating optical disc 102 with a light beam according to instructions from the system controller 107 and the control circuit 109. Such irradiation with the light beam records/reproduces an information signal on/from the optical disc 102.

The optical pickup device 1 also detects various light beams on the basis of the light beam reflected from the signal recording surface of the optical disc 102, as will be described later, so as to supply the signals detected from the beams to the signal processor 120.

The signal processor 120 produces various servo-signals, such as a focusing error signal and a tracking error signal, on the basis of signals detected from the light beams, and it further produces an RF signal that is an information signal recorded on the optical disc. In accordance with kinds of the recording medium to be reproduced, a predetermined processing, such as demodulation and error correction, is performed based on these signals by the control circuit 109 and the signal modulator/demodulator & ECC block 108.

The recorded signal demodulated by the signal modulator/demodulator & ECC block 108 is fed to an external computer 130 via an interface 111 if the signal is for data storage for a computer. The external computer 130 can thereby receive the signal recorded on the optical disc 102 as a reproduced signal.

If the recorded signal demodulated by the signal modulator/demodulator & ECC block 108 is for audio-visual use, the signal is digital/analogue converted by an A/D converting unit of a D/A-A/D converter 112 so as to be fed to an audio-visual processor 113. Then, the signal is audio-video processed in the audio-visual processor 113 so as to be fed to an external image-pickup and projection instrument via an audio-visual signal input/output unit 114.

To the optical pickup device 1, the feed motor 105 is connected. The optical pickup device 1 is fed in the radial direction of the optical disc 102 by the rotation of the feed motor 105, and it is moved to a predetermined recording track on the optical disc 102. The control circuit 109 respectively controls the spindle motor 103, the feed motor 105, and an actuator for displacing an objective lens of the optical pickup device 1 in a focusing direction that is an optical axial direction and a tracking direction that is perpendicular to the optical axial direction.

That is, the control circuit 109 controls the spindle motor 103, and it controls the actuator on the basis of a focusing signal and a tracking error signal.

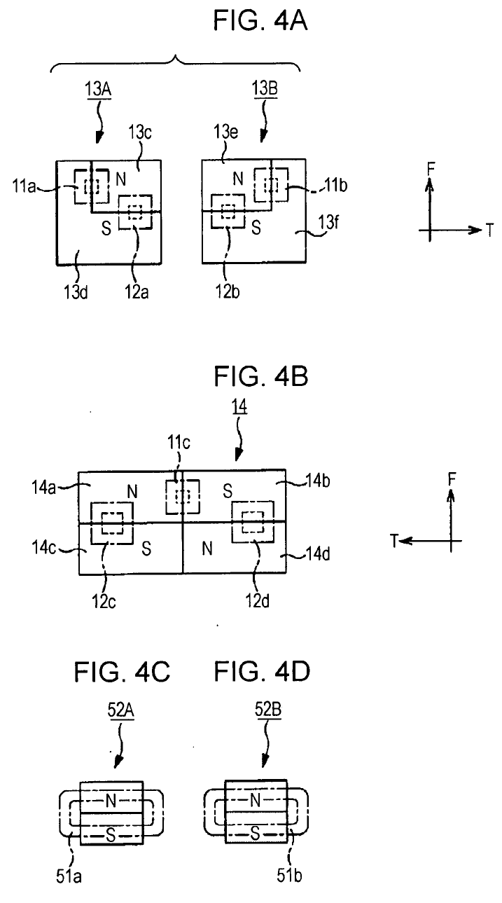

The control circuit 109 also produces a drive signal (drive electric current) to be supplied to tracking coils 11a to 11c and focusing coils 12a to 12d (see FIGS. 4A to 4D), which will be described later, on the basis of a focusing error signal, a tracking error signal, and an RF signal, which are inputted from the signal processor 120.

A laser control unit 121 controls a laser light source in the optical pickup device 1.

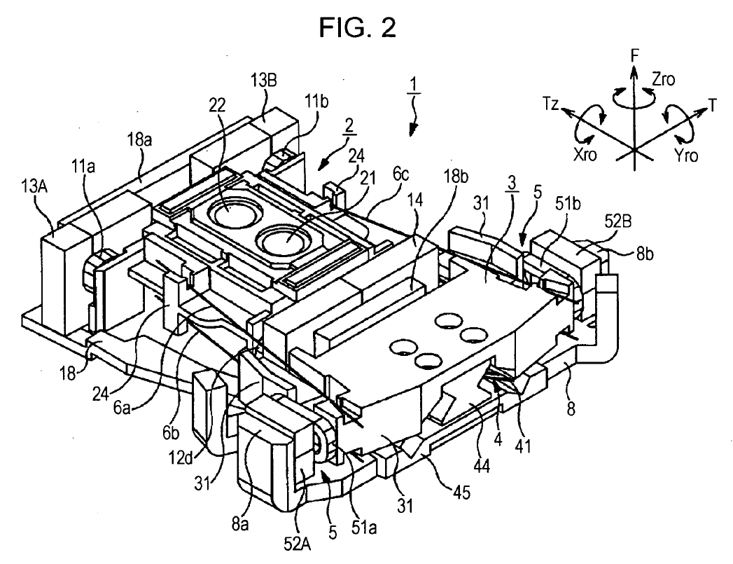

The focusing direction F herein means the optical axial direction of objective lenses 21 and 22 (see FIG. 2) in the optical pickup device 1; the tangential direction Tz means the perpendicular direction to the focusing direction F as well as it is parallel to the tangential direction to the circumference of the optical disc apparatus 101; and the tracking direction T means the direction perpendicular to the focusing direction F and the tangential direction Tz. Also, the angle of difference between 90° and the angle defined by the optical axes of the objective lenses 21 and 22 and the virtual line passing through the optical axes and extending in the radial direction of the optical disc 102 is called as the tilting angle in the radial direction.

The optical disc apparatus 101 is provided with an inclination detection sensor for detecting the inclination of the optical disc 102 attached to the spindle motor 103. The signal detected by the inclination detection sensor is fed to the control circuit 109. The control circuit 109 outputs a tilting angle control signal based on the detected inclination signal so as to supply it to a driving unit 5, which will be described later. The driving unit 5 displaces the objective lenses 21 and 22 by the driving current corresponding to the tilting angle control signal so as to adjust the tilting angle.

Then, the optical pickup device 1 according to the embodiment of the present invention will be described in detail.

The optical pickup device 1 is used for the optical disc apparatus that records and/or reproduces an information signal on/from a plurality of kinds of the optical disc 102 that records or reproduces an information signal selectively using a plurality of kinds of light beam with different wavelengths. Specifically, the optical pickup device 1 will be described to record or reproduce an information signal on or from a first optical disc that records or reproduces an information signal using a light beam with a wavelength of about 400 to 410 nm, on or from a second optical disc that records or reproduces an information signal using a light beam with a wavelength of about 650 to 660 nm, and on or from a third optical disc that records or reproduces an information signal using a light beam with a wavelength of about 760 to 800 nm.

In addition, the optical pickup device 1 will be described below to record or reproduce an information signal on or from three different kinds of optical disc; however, the optical pickup device 1 is not limited to this, so that it may also record and/or reproduce an information signal on/from a plurality of kinds of the optical disc or one kind.

The optical pickup device 1 according to the embodiment of the present invention includes semiconductor laser that includes light sources for emitting the plurality of kinds of laser beam with a different wavelength, a photo-diode that is a light detection element for detecting the light beam reflected from the signal recording surface of the optical disc 102, and an optical system for guiding the light beam from the semiconductor laser to the optical disc 102 as well as for guiding the light beam reflected from the optical disc 102 to the light detection element.

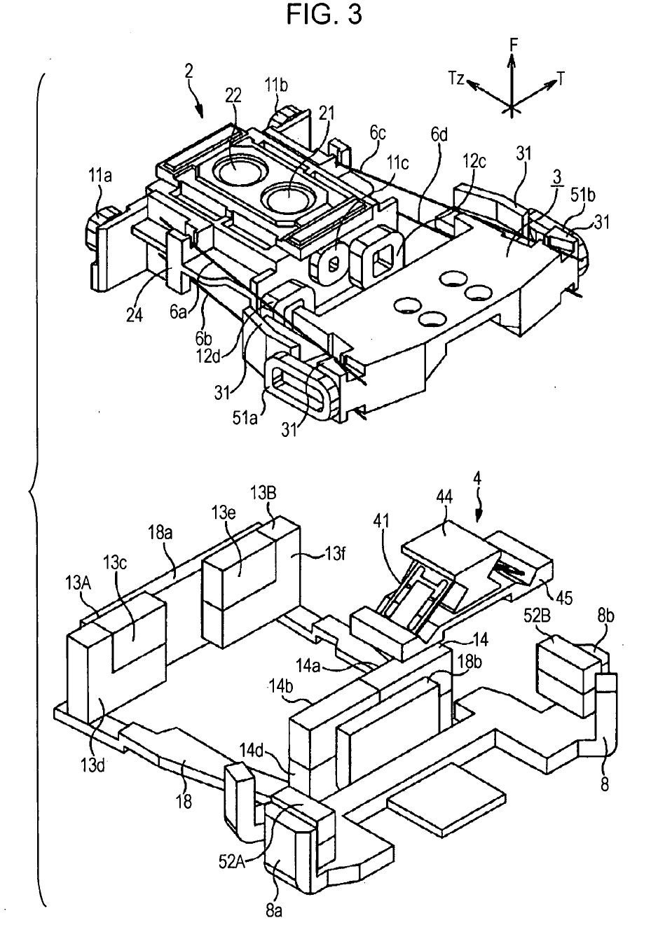

The optical pickup device 1, as shown in FIGS. 2 and 3, is provided on a mounting base arranged movably in the radial direction of the optical disc 102 within a casing of the optical disc apparatus 101.

The optical pickup device 1, as shown in FIGS. 2 to 4D, also includes a lens holder 2 for supporting the plurality of objective lenses 21 and 22 for focusing the light beam emitted from the light source and irradiating the optical disc with the light beam and a support body 3 arranged at a position spaced from the lens holder 2 in the tangential direction Tz and attached on the mounting base. The first and second objective lenses 21 and 22 constitute part of the optical system of the optical pickup device 1.

The first objective lens 21 is used for focusing the light beam with a wavelength of 400 to 410 nm on the first optical disc, and the second objective lens 22 is used for focusing the light beam with a wavelength of 650 to 660 nm and the light beam with a wavelength of 760 to 800 nm on the second or third optical disc. The first and second objective lenses 21 and 22 are juxtaposed in the tangential direction Tz. The first objective lens 21 is arranged adjacent to the support body 3 which is the fixing side of support arms 6a to 6d, which will be described later, and the second objective lens 22 is arranged adjacent to the edge of the lens holder 2.

The optical pickup device 1 is provided with the plurality of objective lenses 21 and 22 juxtaposed in the tangential direction Tz; however, the number of the objective lenses and the arrangement are not limited to these, so that the plurality of objective lenses may be arranged in the radial direction or one objective lens may be provided.

The lens holder 2, as shown in FIGS. 2 and 3, is arranged to surround the peripheries of the first and second objective lenses 21 and 22 so as to support the first and second objective lenses 21 and 22 movably in the focusing direction F in parallel with the optical axis of the objective lens as well as in the tracking direction T perpendicular to the optical axis.

The lens holder 2, as shown in FIGS. 2 to 4D, is provided with first to third tracking coils 11a to 11c attached on side faces of the lens holder 2 opposing each other in the tangential direction Tz for generating a drive force in the tracking direction Tz, which is a substantially radial direction of the optical disc 102, and first to fourth focusing coils 12a to 12d attached on the side faces of the lens holder 2 opposing each other in the tangential direction Tz for generating a drive force in the focusing direction F, which includes directions closing to and separating from the optical disc 102.

On each side separated from each other in the tracking direction T of the lens holder 2, a pair of support arms 6a and 6b (6c and 6d) and an arm support 24 for supporting the support arms are arranged.

Between the lens holder 2 and the mounting base (not shown), as shown in FIGS. 2 and 3, a yoke 18 is provided. The yoke 18 is attached on a base 8 and is fixed on the mounting base. The yoke 18 is provided with an opening formed at substantially the center of the yoke 18 for making a light beam incident in the first and second objective lenses 21 and 22 pass through.

On each side in the tangential direction Tz of the yoke 18, as shown in FIGS. 2 and 3, a pair of yoke pieces 18a and 18b are raised to oppose each other with the first and second objective lenses 21 and 22 therebetween. On surfaces of the yoke pieces 18a and 18b opposing each other, first and second magnets 13A and 13B and a third magnet 14 are attached. The first and second magnets 13A and 13B herein are positioned on the movable side, i.e., adjacent to the edge of the lens holder 2 while the third magnet 14 is arranged on the fixed side, i.e., adjacent to the support body 3.

The first and second magnets 13A and 13B, as shown in FIGS. 2 to 4A, are arranged to oppose the lens holder 2 in the tangential direction Tz, and include first and second divided regions 13c and 13d and third and fourth divided regions 13e and 13f, respectively, each region being polarized in any one of the tangential directions Tz.

The first divided region 13c is made in a roughly rectangular shape, and is polarized to have an N-pole on the surface adjacent to the lens holder 2. The second divided region 13d, including a portion neighboring the first divided region 13c in the focusing direction F and a portion neighboring it in the tracking direction T, is shaped to surround one side of the first divided region 13c in the focusing direction and one side in the tracking direction. The second divided region 13d is polarized in a direction opposite to that of the first divided region 13c, i.e., to have an S-pole on the surface adjacent to the lens holder 2. The third and fourth divided regions 13e and 13f are polarized symmetrically in shape to the first divided region 13c and 13d in the focusing direction F.

The N-pole and the S-pole of the first to fourth divided regions of the first and second magnets 13A and 13B are not limited to those as above-mentioned, so that they may be opposite, for example.

The third magnet 14, as shown in FIGS. 2, 3, and 4B, is arranged to oppose the lens holder 2 in the tangential direction Tz on the side opposite to the first and second magnets 13A and 13B, and includes fifth to eighth divided regions 14a to 14d, each region being polarized in any one of the tangential directions Tz.

The fifth to eighth divided regions 14a to 14d herein are formed by dividing the third magnet 14 into two in the focusing direction F as well as by dividing it into two in the tracking direction T, each region being formed in a roughly rectangular shape. The fifth and eighth divided regions 14a and 14d are polarized to have the N-pole on the surface adjacent to the lens holder 2 while the sixth and seventh divided regions 14b and 14c are polarized to have the S-pole on the surface adjacent to the lens holder 2.

The above-mentioned N-pole and the S-pole of the fifth to eighth divided regions of the third magnet 14 may also be opposite.

As described above, the first to third magnets 13A, 13B, and 14 oppose tracking coils 11a to 11c and focusing coils 12a to 12d, which are attached on side surfaces of the lens holder 2 opposing each other, respectively, so as to apply a predetermined magnetic field to each opposing coil.

The tracking coils 11a to 11c, as shown in FIGS. 4A and 4B, are arranged at a position neighboring the first and second divided regions 13c and 13d of the first magnet 13A in the tracking direction T, a position neighboring the third and fourth divided regions 13e and 13f of the second magnet 13B in the tracking direction T, and a position opposing the first and second divided regions 14a and 14b of the third magnet 14, respectively, so as to generate a drive force in the tracking direction T with a magnetic field generated in each divided region and the direction and intensity of a current passing through each coil.

The focusing coils 12a to 12d, as shown in FIGS. 4A and 4B, are arranged at a position neighboring the first and second divided regions 13c and 13d of the first magnet 13A in the focusing direction F, a position neighboring the third and fourth divided regions 13e and 13f of the second magnet 13B in the focusing direction F, a position opposing the first and third divided regions 14a and 14c of the third magnet 14, and a position opposing the second and fourth divided regions 14b and 14d of the third magnet 14, respectively, so as to generate a drive force in the tracking direction T with a magnetic field generated in each divided region and the direction and intensity of a current passing through each coil.

In such a manner, the tracking coils 11a and 11b and the focusing coils 12a and 12b oppose the first and second magnets 13A and 13B, respectively, while the tracking coil 11c and the focusing coils 12c and 12d oppose the third magnet 14. Thus, when a tracking drive current is supplied to the tracking coils 11a to 11c, the lens holder 2 is displaced in the tracking direction T by the interaction between the drive current applied to each tracking coil and the magnetic field of each magnet. When a focusing drive current is supplied to the focusing coils 12a to 12d, the lens holder 2 is displaced in the focusing direction F by the interaction between the drive current applied to each focusing coil and the magnetic field of each magnet.

Consequently, the first and second objective lenses 21 and 22 supported by the lens holder 2 are displaced in the focusing direction F or the tracking direction T, so that the light beam irradiating the optical disc 102 via the first and second objective lenses 21 and 22 is controlled to focus the signal recording surface of the spindle motor 103 (focusing control), and the light beam is controlled to follow up the recording track formed on the optical disc 102 (tracking control).

The support body 3, as shown in FIGS. 2 and 3, has a length along the lens holder 2 in the tracking direction T and a height in the focusing direction F.

On each side of the support body 3 separated from each other in the tracking direction T, an arm support 31 is arranged for supporting a pair of support arms 6a and 6b (6c and 6d) with a space in the focusing direction F. On the back side of the support body 3, a printed circuit board (not shown) is attached. To the printed circuit board, the focusing drive current and the tracking drive current are supplied from the control circuit 109.

The arm support 24 arranged on each side in the tracking direction T of the lens holder 2 and the arm support 31 arranged on each side in the tracking direction of the support body 3 are connected together with one pair of the support arms 6a and 6b or the other pair of the support arms 6c and 6d. The one pair of the support arms 6a and 6b and the other pair of the support arms 6c and 6d, as shown in FIG. 2, are respectively arranged in parallel to each other with a space in the focusing direction F so as to support the lens holder 2 movably in the focusing direction F and the tracking direction T relative to the support body 3. These support arms 6a to 6d are made of a linear member having conductivity and elasticity.

In a pair of the support arms 6a and 6b arranged on one side of the support body 3, ends adjacent to the lens holder 2 are connected to contact buttons provided in the focusing coils 12a to 12d by soldering while ends adjacent to the support body 3 are connected to a conductive pattern provided in the printed circuit board. Thus, the focusing drive current from the control circuit 109 is supplied to the focusing coils 12a to 12d via the support arms 6a and 6b.

Similarly, in the support arms 6c and 6d arranged on the other side of the support body 3, ends adjacent to the lens holder 2 are connected to contact buttons provided in the tracking coils 11a to 11c by soldering while ends adjacent to the support body 3 are connected to a conductive pattern provided in the printed circuit board. Thus, the tracking drive current from the control circuit 109 is supplied to the tracking coils 11a to 11c via the support arms 6c and 6d.

The lens holder 2 having the first and second objective lenses 21 and 22 attached thereto is supported with the support arms 6a and 6b at both side of the intermediate portion between optical axes of the first and second objective lenses 21 and 22 in the extending direction of the support arms 6a to 6d. That is, the lens holder 2 is supported dispaceably at least in biaxial directions of the focusing direction F and the tracking direction T by fixing end portions of the support arms 6a and 6b to the arm supports 24 provided on both sides of the intermediate portion between optical axes of the first and second objective lenses 21 and 22.

It is desirable that the position of the lens holder 2 supported by end portions of the support arms 6a and 6b be located on both sides of the center of gravity of the lens holder 2 having the tracking coils 11a to 11c and the focusing coils 12a to 12d attached thereto. By the supporting at such a position, the first and second objective lenses 21 and 22 can be stably displaced in the focusing direction F and the tracking direction T without being twisted.

The optical pickup device 1 according to the embodiment of the present invention includes an elastic support member 4 for tiltably supporting the support body 3, which supports the lens holder 2 via a pair of the support arms 6a/6b and 6c/6d on either side, to a base 8; and a driving unit 5 for inclining the support body 3, which is tiltably supported by the elastic support member 4, about the tangential axis Tz, i.e., in a tilting direction, in accordance with the inclination of the optical disc 102.

The natural frequency of the elastic support member 4 in modes of natural vibration in a rotational direction about the focusing axis F, a rotational direction about the tracking axis T, and a rotational direction about the tangential axis Tz is larger than the rotational frequency of the optical disc 102 as well as it is to be small to some extent of not impairing the servo-stability. The frequency band used in the servo-control will be described below as about 1.5 to 40 kHz when the rotation frequency of the optical disc is about 80 Hz (number of revolutions of the optical disc is 5000 rpm); however, the elastic support member constituting the optical pickup device according to the embodiment of the present invention is not limited to this. That is, the elastic support member can have a desired frequency by the specific configuration, which will be described later, so that the elastic support member may be configured to have a frequency smaller than the frequency band used in the servo-control as well as larger than the rotation frequency. The frequency band used in the servo-control herein means a frequency range difficult to stabilize servo-characteristics.

Specifically, the elastic support member 4 is configured so that a natural frequency Xro of the whole optical pickup device in a mode of natural vibration in a rotational direction about the tangential axis Tz, a natural frequency Yro in a mode of natural vibration in a rotational direction about the tracking axis T, and a natural frequency Zro in a mode of natural vibration in a rotational direction about the focusing axis F have a value ranging from 80 to 1500 Hz, respectively.

The elastic support member 4 includes a pair of plate-like support legs 41 and 41 that are inclined to expand the space between the legs from one ends supporting the support body 3 toward the other ends fixed to the base 8. By the support legs 41 and 41, the support body 3 is supported to the base 8 tiltably about the tangential axis Tz, i.e., in a tilting direction (so called radial tilting direction).

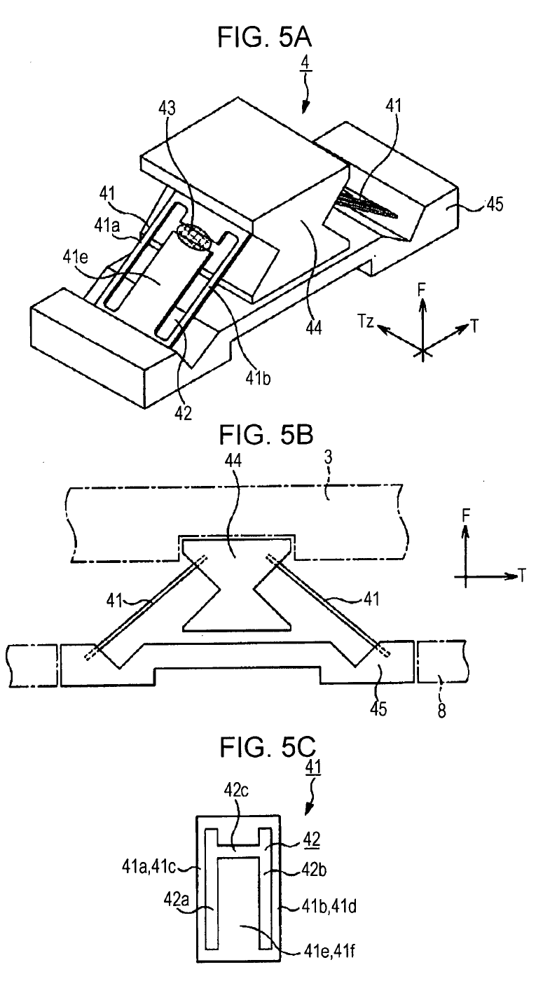

A pair of the support legs 41 and 41 of the elastic support member 4, as shown in FIGS. 5A and 5B, are made of a leaf spring member that is a metallic plate-like member with elasticity. By forming cut-outs 42 and 42, a plurality of support pieces 41a to 41d are formed from the one ends supporting the support body 3 toward the other ends fixed to the base 8 while tongue pieces 41e and 41f are linked to the other ends fixed to the base 8.

Namely, a pair of the support legs 41 and 41, as shown in FIG. 5C, are provided with the cut-outs 42 and 42 constituted of a pair of roughly rectangular cut-outs 42a and 42b formed from the one ends toward the other ends and a cut-out 42c formed in the tangential direction Tz perpendicular to the pair of the cut-outs 42a and 42b for connecting the cut-outs 42a and 42b together. One support leg 41 includes the first and second support pieces 41a and 41b and the first tongue piece 41e, which are formed by the cut-out 42. The other support leg 41 includes the third and fourth support pieces 41c and 41d and the second tongue piece 41f, which are formed by the cut-out 42. To the first and second tongue pieces 41e and 41f, a damping material 43 is applied for reducing the gain of unnecessary resonance.

In addition, furthermore, the damping material 43 may be applied on a surface of the yoke piece 18b of the yoke 18 attached on the base 8 opposing the support body 3 so as to further reduce the gain of unnecessary resonance. The position of the damping material 43 applied between the base 8 and the support body 3 is not limited to these, so that the damping material 43 may be applied between a member raised integrally with the base 8 or a member fixed to the base 8 and the support body 3; alternatively, between the base 8 and the bottom of the support body 3.

The tongue pieces 41e and 41f are linked to the other ends of the support legs 41 and 41 of the elastic support member 4; alternatively, the tongue pieces may be formed to link to the one ends supporting the support body 3.

In the elastic support member 4, one ends of a pair of the support legs 41 and 41 are attached to the support body 3 via a support body mounting member 44 while the other ends are attached to the base 8 via a base mounting member 45. In such a manner, the elastic support member 4 is fixed to the support body 3 and the base 8 with the support body mounting member 44 and the base mounting member 45, respectively, so that the support body 3 is tiltably supported to the base 8. The elastic support member 4, the support body mounting member 44, and the base mounting member 45 are integrally molded by insert molding; however, the forming is not limited to the insert molding, so that the independently formed elastic support member 4 may be inserted into the support body mounting member 44 and the base mounting member 45, and integrally fixed thereto with an adhesive. In the elastic support member 4 configured as above, by forming the cut-outs 42 and 42, the natural frequency in each direction can be reduced. That is, by supporting the support body 3 with the first to fourth support pieces 41a to 41d formed by the cut-outs 42 and 42, the natural frequency in each direction can be reduced smaller in comparison with the case without the cut-outs. Namely, by reducing the natural frequency from 1500 Hz, the frequency can be lowered than that used in the servo-control, preventing the resonance due to the natural vibration generated by the servo-control.

Furthermore, in the elastic support member 4, by reducing the natural frequency in such a manner, the effect of the damping material 43 can be taken, facilitating the servo-control by reducing the gain of unnecessary resonance for lowering the resonance level. When the damping material 43 is also applied between the base 8 and the support body 3 as mentioned above, in the elastic support member 4, by reducing the natural frequency, the effect of this damping material can be taken, facilitating the servo-control by lowering the resonance level.

In the elastic support member 4, during forming the cut-outs 42 and 42, by adjusting the first to fourth support pieces 41a to 41d so that their widths are not excessively reduced, the natural frequency in each direction can become larger than the rotation frequency of the optical disc, preventing the resonance due to the vibration from a spindle motor for rotating the optical disc.

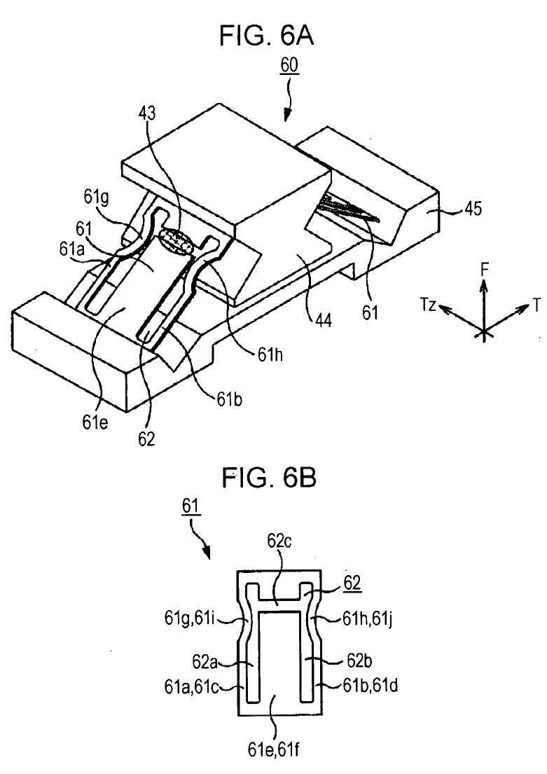

The elastic support member constituting the optical pickup device according to the embodiment of the present invention is not limited to the elastic support member 4 shown in FIGS. 5A to 5C, so that it may also be configured as shown in FIGS. 6A and 6B.

In an elastic support member 60 shown in FIG. 6A, the support body 3 is supported to the base 8 tiltably in the tilting direction. The elastic support member 60 includes a pair of plate-like support legs 61 and 61 that are inclined to expand the space between the legs from one ends supporting the support body 3 toward the other ends fixed to the base 8.

A pair of the support legs 61 and 61 of the elastic support member 60, as shown in FIG. 6A, are made of a leaf spring member. By forming cut-outs 62 and 62, a plurality of support pieces 61a to 61d are formed from the one ends supporting the support body 3 toward the other ends fixed to the base 8 while tongue pieces 61e and 61f are linked to the other ends fixed to the base 8. A plurality of the support pieces 61a to 61d are provided with flections 61g, 61h, 61i, and 61j formed thereto, respectively. The flections 61g to 61j are curvedly formed on the plane of the plate-like member.

Namely, a pair of the support legs 61 and 61 of the elastic support member 60, as shown in FIG. 6B, are provided with the cut-outs 62 and 62 constituted of a pair of cut-outs 62a and 62b formed from the one ends toward the other ends and a cut-out 62c formed in the tangential direction Tz perpendicular to the pair of the cut-outs 62a and 62b for connecting the cut-outs 62a and 62b together. One support leg 61 includes the first and second support pieces 61a and 61b formed by the support legs 61 and 61, the flections 61g and 61h, and a first tongue piece 61e, which are formed on the first and second support pieces 61a. The other support leg 61 includes the third and fourth support pieces 61c and 61d foamed by the cut-outs 62 and 62, the flections 61i and 61j respectively formed on the third and fourth support pieces, and a second tongue piece 61f. To the first and second tongue pieces 61e and 61f, the damping material 43 is applied for reducing the gain of unnecessary resonance.

The tongue pieces 61e and 61f are linked to the other ends of the support legs 61 and 61 of the elastic support member 60; alternatively, the tongue pieces may be formed to link to the one ends supporting the support body 3.

In the elastic support member 60, in the same way as in the elastic support member 4, one ends of a pair of the support legs 61 and 61 are attached to the support body 3 via the support body mounting member 44 while the other ends are attached to the base 8 via the base mounting member 45. In such a manner, the elastic support member 60 is fixed to the support body 3 and the base 8 with the support body mounting member 44 and the base mounting member 45, respectively, so that the support body 3 is tiltably supported to the base 8. The elastic support member 60, the support body mounting member 44, and the base mounting member 45 are integrally molded by insert molding, for example.

In the elastic support member 60 configured as above, by forming the cut-outs 62 and 62, the natural frequency in each direction can be reduced. That is, by supporting the support body 3 with the first to fourth support pieces 61a to 61d formed by the cut-outs 62 and 62, the natural frequency in each direction can be reduced smaller in comparison with the case without the cut-outs. Furthermore, by providing the flections 61g to 61j in the first to fourth support pieces 61a to 61d, respectively, the natural frequency in each direction is further reduced. Namely, by reducing the natural frequency from 1500 Hz, for example, the frequency can be lowered than that used in the servo-control, preventing the resonance due to the natural vibration generated by the servo-control.

Furthermore, in the elastic support member 60, by reducing the natural frequency in such a manner, the effect of the damping material 43 can be taken, facilitating the servo-control by reducing the gain of unnecessary resonance for lowering the resonance level. When the damping material 43 is also applied between the base 8 and the support body 3 as mentioned above, in the elastic support member 60, by reducing the natural frequency, the effect of this damping material can be taken, facilitating the servo-control by lowering the resonance level.

In the elastic support member 60, during forming the cut-outs 62 and 62, by adjusting the first to fourth support pieces 61a to 61d so that their widths are not excessively reduced, the natural frequency in each direction can become larger than the rotation frequency of the optical disc, preventing the resonance due to the vibration from the spindle motor for rotating the optical disc.

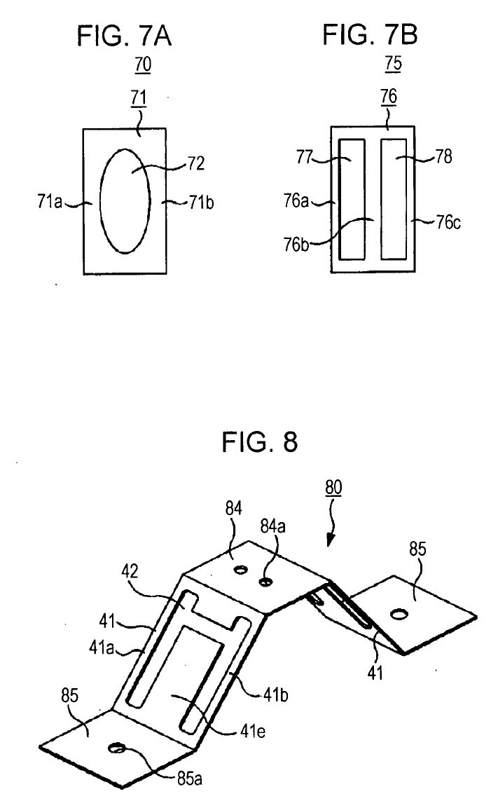

The elastic support member constituting the optical pickup device according to the embodiment of the present invention is not limited to the elastic support members 4 and 60 shown in FIGS. 5A to 6B, so that it may also be configured as shown in FIG. 7A or 7B, for example. Elastic support members 70 and 75, which will be described with reference to FIGS. 7A and 7B, in the same way as in the elastic support members 4 and 60 described above, include a pair of plate-like support legs 71 and 71 (76 and 76) that are inclined to expand the space between the legs from one ends supporting the support body 3 toward the other ends fixed to the base 8. By the support legs, the support body 3 is supported to the base 8 tiltably in the tilting direction. One support leg 71 (76) will be only described below with reference to FIGS. 7A and 7B, and the detailed description of the other support leg and other configurations is omitted.

In the support leg 71, made of a leaf spring member, of the elastic support member 70 shown in FIG. 7A, by forming a roughly elliptic cut-out 72, a plurality of support pieces 71a and 71b are formed from one end supporting the support body 3 toward the other end fixed to the base 8.

In the support leg 76, made of a leaf spring member, of the elastic support member 75 shown in FIG. 7B, by forming a plurality of roughly rectangular cut-outs 72 78, a plurality of support pieces 76a to 76c are formed from one end supporting the support body 3 toward the other end fixed to the base 8.

In the elastic support members 70 and 75 configured as above, by forming the cut-outs 72 and 72 (77 and 77), the natural frequency in each direction can be reduced. That is, by supporting the support body 3 with a plurality of support pieces formed by the cut-outs, the natural frequency in each direction can be reduced smaller in comparison with the case without the cut-outs. Namely, by reducing the natural frequency to a desired range, the frequency can be lowered than that used in the servo-control, and furthermore, during forming the cut-outs 72, 77, and 78, by adjusting the shape of each support piece, the natural frequency in each direction can become larger than the rotation frequency of the optical disc, preventing the resonance due to the natural vibration.

The elliptic cut-outs 72 and 72 and a plurality of the roughly rectangular cut-outs have been described in the above; however, the cut-out is not limited to these, so that the elastic support member may be configured by selectively providing one or a plurality of circular, elliptic, or roughly rectangular cut-outs, for example. Alternatively, by providing cut-outs constituted of a plurality of cut-outs formed in different directions as mentioned above, the elastic support member may be configured.

The elastic support member constituting the optical pickup device according to the embodiment of the present invention, as shown in FIG. 8, may also be configured by bending one sheet of a leaf spring member. An elastic support member 80 shown in FIG. 8 includes the support legs 41 and 41 identical to those of the elastic support member 4, so that the detailed description of this configuration is omitted.

The elastic support member 80 shown in FIG. 8 is formed by bending a strip leaf spring member, and includes a support body mounting piece 84 to be fixed to the support body 3, a pair of the support legs 41 and 41 extending from both ends of the support body mounting piece 84, and base mounting pieces 85 extending from ends of the support legs to be mounted on the base 8. The support body mounting piece 84 and the base mounting piece 85 are provided with through holes 84a and 85a formed for being fixed to the support body 3 and the base 8 therethrough with screws, respectively.

In the elastic support member 80 configured in such a manner, in the same way as in the elastic support member 4 described above, by forming the cut-outs 42 and 42, the natural frequency in each direction can be reduced. That is, by supporting the support body 3 with a plurality of support pieces 41a to 41d formed by the cut-outs, the natural frequency in each direction can be reduced to a desired range. Namely, the natural frequency in each direction is lowered than the frequency used in the servo-control as well as is increased higher than the rotation frequency of the optical disc, preventing the resonance due to the natural vibration.

The support legs 41 and 41 herein are formed by bending a strip leaf spring member; alternatively, any configuration of the support legs described above may be adopted.

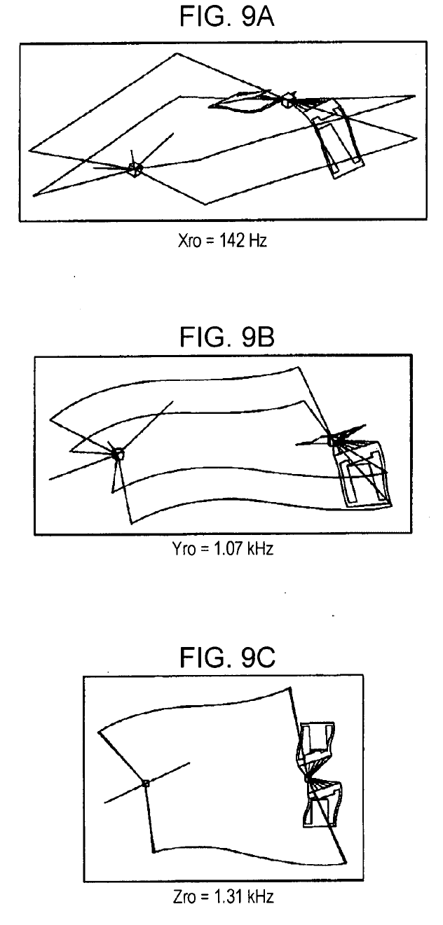

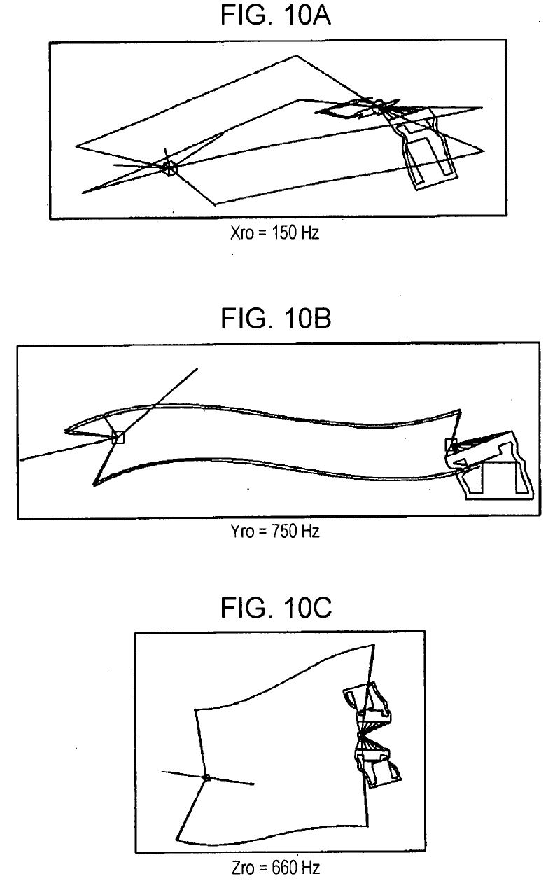

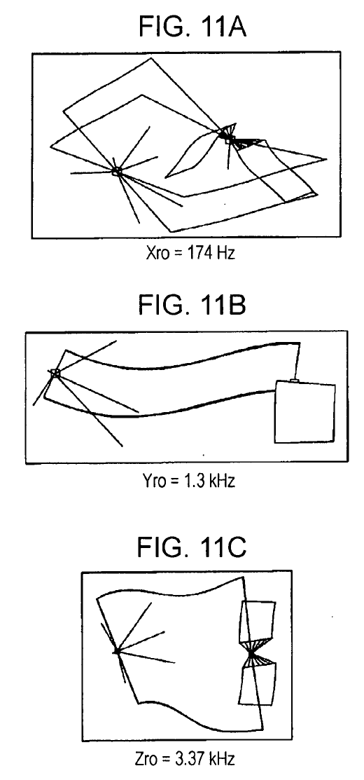

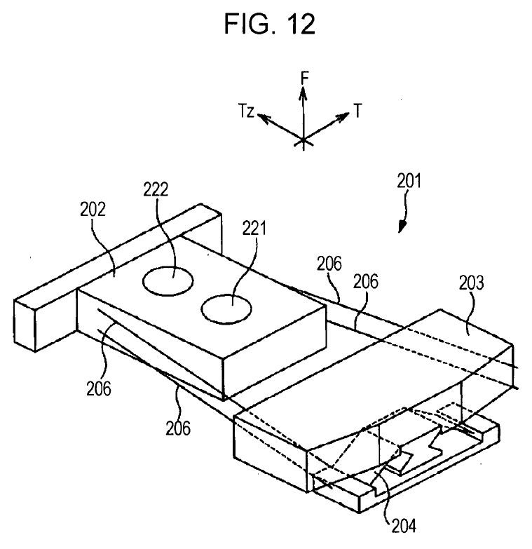

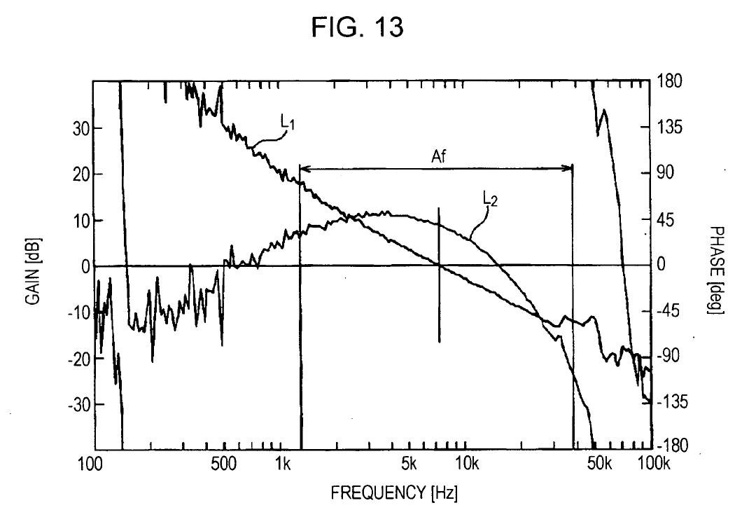

Then, FIGS. 9A to 10C show the simulated results of natural frequencies Xro, Yro, and Zro in modes of natural vibration in each rotational direction about each axis of the optical pickup device 1 having the elastic support members 4 and 60. As a comparative example, FIGS. 11A to 11C show the simulated results of natural frequencies in modes of natural vibration in each rotational direction about each axis of an optical pickup device in related art having the elastic support member 204 without cut-outs shown in FIG. 12. The simulations were performed under the same condition other than the elastic support members 4, 60, and 204.

FIGS. 9A to 11C are drawings schematically showing deformation states of each elastic support member when the free end of the elastic support member, which is the lens holder movable side, is displaced relative to the fixed end adjacent to the support body 3. FIGS. 9A to 9C are schematic views showing the simulated results of natural frequencies in modes of natural vibration in each rotational direction when the elastic support member 4 shown in FIGS. 5A to 5C is included; FIGS. 10A to 10C are schematic views showing the simulated results of natural frequencies in modes of natural vibration in each rotational direction about each axis when the elastic support member 60 shown in FIGS. 6A and 6B is included; and FIGS. 11A to 11C are schematic views showing the simulated results of natural frequencies in modes of natural vibration in each rotational direction when the elastic support member 204 shown in FIG. 12 is included.

FIGS. 9A, 10A, and 11A show natural vibration states in a mode of natural vibration in a rotational direction about the tangential axis Tz; FIGS. 9B, 10B, and 11B show natural vibration states in a mode of natural vibration a rotational direction about the tracking axis T, i.e., natural vibration states when the lens holder 2, which is the free end, is rotated about the tracking axis T; and FIGS. 9C, 10C, and 11C show natural vibration states in a mode of natural vibration in a rotational direction about the focusing axis F.

First, in the elastic support member 4 shown in FIGS. 5A to 5C, Xro=142 Hz, Yro=1070 Hz=1.07 kHz, and Zro=1310 HZ=1.31 kHz, as shown in FIGS. 9A to 9C. Whereas, in the elastic support member 204 in related art, Xro=174 Hz, Yro=1300 Hz=1.3 kHz, and Zro=3370 HZ=3.37 kHz, as shown in FIGS. 11A to 1C. These results show that the elastic support member 4 can lower the natural frequency in modes of natural vibration in each rotational direction lower than the frequency band used in the servo-control as well as higher than the rotation frequency of the optical disc.

In the elastic support member 60 having the flections shown in FIGS. 6A and 6B, Xro=150 Hz, Yro=750 Hz, and Zro=660 Hz, as shown in FIGS. 10A to 10B. These results show that, in comparison with the results of the elastic support member 204 in related art shown in FIGS. 11A to 1C, the elastic support member 60 can lower the natural frequency in modes of natural vibration in each rotational direction lower than the frequency band used in the servo-control as well as higher than the rotation frequency of the optical disc.

In the elastic support members 4 and 60 shown in FIGS. 5A to 6B, the damping material 43 can take the effect by lowering the natural frequency and the servo-control is facilitated by lowering the resonance level.

The elastic support members 4 and 60 configured as described above, as shown in the simulations mentioned above, can lower the natural frequency in each rotational direction in comparison with the elastic support member 204 in related art. Namely, the natural frequency can be reduced to a desired range so as to obtain high servo-stability by preventing the resonance due to natural vibration.

The driving unit 5, as shown in FIGS. 2 and 3, includes tilting coils 51a and 51b arranged on both sides in the tracking direction T of the support body 3 and magnets 52A and 52B arranged in mounting portions 8a and 8b raised from the base 8. The magnets 52A and 52B, as shown in FIGS. 4C and 4D, are so-called flat bipolar polarized magnets and fixed to the mounting portions 8a and 8b with an adhesive, respectively.

The tilting magnets 52A and 52B, as shown in FIGS. 2, 4C, and 4D, are fixed so that an N-pole and an S-pole are arranged to have a polarization line perpendicular to the focusing direction F of the first and second objective lenses 21 and 22.

Then, when drive current is passed through the tilting coils 51a and 51b, due to the effects of the currents passing through the tilting coils 51a and 51b and the magnetic fields of the tilting magnets 52A and 52B, a force driving the tilting coils 51a and 51b relative to the magnets 52A and 52B, i.e., a force driving the elastic support member 4 and the support body 3 supported by the elastic support member 4 relative to the base 8 is generated. At this time, the force driving the tilting coils 51a and 51b is generated in an opposite direction to the focusing axis F. Since the elastic support member 4 made of a leaf spring member includes a pair of the non-parallel support legs 41 and 41, and the support body 3 is supported by the elastic support member 4 shaped in a trapezoid as a whole, the position of the support body 3 is changed according to the profile of the elastic support member 4 when the driving force is applied.

By the way, the elastic support member 4 is shaped to have a predetermined rigidity against twisting as well as to have the natural frequency in each direction within a desired range as described above. In the elastic support member 4, the support body mounting member 44 is fixed to the support body 3 while the base mounting member 45 is fixed to the base 8, so that the support legs 41 and 41 can be elastically deformed backwardly when the driving force is applied.

Then, the operation of the optical pickup device 1 having the driving unit 5 for driving the support body 3 mentioned above will be described.

When no electricity is sent to the tilting coils 51a and 51b of the driving unit 5, the elastic support member 4 does not deform and the optical pickup device 1 is under a neutral condition. At this time, the configuration of the elastic support member 4 is established to keep the first and second objective lenses 21 and 22 supported by the lens holder 2 in a horizontal position.

When a driving current is supplied to the tilting coils 51a and 51b, the current passes through the tilting coils 51a and 51b existing in the magnetic field of the magnets 52A and 52B so as to generate a force driving the support body 3 in the tilting direction. Since the support body 3 is supported by the trapezoidal elastic support member 4 having the non-parallel support legs 41 and 41, the position of the support body 3 is controlled to tilt according to the profile of the elastic support member 4 when the driving force is applied.

Since the support body 3 supports the lens holder 2 with the four support arms 6a to 6d, the lens holder 2 is inclined by the inclination of the support body 3. Thereby, by supplying the driving current to the tilting coils 51a and 51b in response to a predetermined control signal, the optical axes of the first and second objective lenses 21 and 22 supported by the lens holder 2 can be inclined in accordance with a warp of the optical disc (tilting angle control). The inclining direction of the support body 3 can be switched by changing the driving current supplied to the tilting coils 51a and 51b from one direction to another. The angle of inclination of the support body 3 can be adjusted to a predetermined angle by the voltage of the driving current supplied to the tilting coils 51a and 51b.

In such a manner, the driving unit 5 can apply the driving force that inclines the support body 3 in the tilting direction by passing the driving current through the tilting coils 51a and 51b to the support body 3 so as to incline the lens holder 2 and the objective lenses 21 and 22 supported by the support body 3.

In such an optical pickup device 1, for obtaining a control signal to be supplied to the tilting coils 51a and 51b shown in FIGS. 2, 4C, and 4D, a detection sensor may be provided for detecting the inclination of the optical disc 102. Then, by controlling the driving current to be supplied to the tilting coils 51a and 51b in accordance with the output of the inclination detecting sensor, the lens holder 2 is rotated in response to the inclination of the disc surface due to a warp of the optical disc 102. This operation may be performed when the optical disc 102 is first mounted on the spindle motor 103 so as to maintain the inclination of the lens holder 2 during reproducing (static inclination correction). Alternatively, in the same way as in focusing control and tracking control, which will be described later, the tilting control signal is continually detected so that in accordance with the tilting control signal, the inclination may be dynamically corrected during recording and reproducing.

As described above, while by providing the driving unit 5 for driving the support body 3, the lens holder 2 is inclined, by providing the detection sensor for detecting the inclination of the optical disc, the first and second objective lenses 21 and 22 can be tilted by the amount corresponding to a warp of each individual optical disc so as to correct the optical axes of the first and second objective lenses 21 and 22 to be perpendicular to the surface of the optical disc. Thereby, the optical spot formed by focusing a light beam on the signal recording surface of the optical disc can be fairly and typically shaped. The manual adjustment of the inclination of the lens holder 2 can also be eliminated.

Then, the focusing control and the tracking control of the lens holder 2 will be described. When the driving current corresponding to the focusing control signal generated from the reproducing signal is fed through the focusing coils 12a to 12d, due to the effects of the currents passing through the focusing coils 12a to 12d and the magnetic fields formed by the yoke 18, the yoke pieces 18a and 18b, and the magnets 13A, 13B, and 14 supported by the yoke pieces 18a and 18b, a force is generated for raising or lowering the lens holder 2 in parallel with the optical axes of the first and second objective lenses 21 and 22 corresponding to the direction of the driving current. Since the lens holder 2 is supported to one end portions of the four support arms 6a to 6d, when the lens holder 2 receives the raising/lowering force, the lens holder 2 is vertically raised/lowered while maintaining the position parallel with the optical disc 102 rotated by the spindle motor 103. Thereby, the objective lenses 21 and 22 are focusing controlled along the optical axes, so that the optical spot from the objective lenses 21 and 22 is focused onto the track of the optical disc.

Also, when the driving current corresponding to the tracking control signal generated from the reproducing signal is fed through the tracking coils 11a to 11c, due to the effects of the currents passing through the tracking coils 11a to 11c and the magnetic fields formed by the yoke 18, the yoke pieces 18a and 18b, and the magnets 13A, 13B, and 14 supported by the yoke pieces 18a and 18b, a force is generated for moving the lens holder 2 in an outer radial direction or an inner radial direction of the optical disc 102 rotated by the spindle motor 103 corresponding to the direction of the driving current. Since the lens holder 2 is supported to one end portions of the four support arms 6a to 6d, when the lens holder 2 receives the force in the direction parallel with the plane of the optical disc 102, the lens holder 2 is displaced in a direction substantially parallel with the normal line of the recording track formed on the optical disc 102. Thereby, the objective lenses 21 and 22 are tracking controlled to move in the radial direction of the optical disc 102, so that the light beam emitted from the first and second objective lenses 21 and 22 can trace the desired recording track.

In the optical pickup device 1 configured as described above, by providing the focusing coils 12a to 12d, the tracking coils 11a to 11c, and the magnets 13A, 13B, and 14, the support arms 6a to 6d are elastically displaced so that the objective lenses 21 and 22 held by the lens holder 2 can be displaced in the focusing direction F and the tracking direction T.

In the optical pickup device 1, by providing the tilting coils 51a and 51b and the bipolar polarized magnets 52A and 52B, the elastic support member 4 is elastically displaced so that the support body 3 and the objective lenses 21 and 22 held by the lens holder 2 can be displaced about the tangential axis Tz, i.e., in the tilting direction.

In accordance with a focus error signal, a tracking error signal, and a tilting control signal, the optical pickup device 1 can precisely displace the objective lenses 21 and 22, achieving the characteristic improvement in recording and reproducing an information signal.

In the optical pickup device 1, the support spring system is complicated due to the configuration in that the lens holder 2 having the first and second objective lenses 21 and 22 is supported to the support body 3 movably in the focusing direction and the tracking direction, i.e., the configuration in that the lens holder 2 is supported to the support body 3 via the support arms 6a to 6d, and the configuration in that the support body 3 is supported to the elastic support member 4 tiltably in the tilting direction, so that the unnecessary resonance is generated in the support body 3 and the lens holder 2 to have a problem. Specifically, this unnecessary resonance includes rolling about the tangential axis Tz of the support body 3 and the lens holder 2, pitching about the tracking axis T, and yawing about the focusing axis F.

In the optical pickup device 1 according to the embodiment of the present invention, the elastic support member 4 supporting the support body 3 to the base 8 is configured so that the natural frequency in modes of natural vibration in a rotational direction about the focusing axis, a rotational direction about the tracking axis, and a rotational direction about the tangential axis is maintained within a predetermined range, thereby reducing the unnecessary resonance without complicated adjustment to have favorable servo-characteristics. That is, the optical pickup device 1 according to the embodiment of the present invention can eliminate the complicated adjustment for suppressing the natural frequency without deteriorating the servo-characteristics so as to obtain the favorable servo-characteristics as well as to achieve the simplified process and low cost. Furthermore, an information signal can be satisfactorily recorded on and/or reproduced from an optical disc.

Thus, in the optical pickup device 1 according to the embodiment of the present invention, the lens holder 2 is supported to the support body 3, which is tiltably supported by the elastic support member 4 relative to the base 8, so that the objective lenses 21 and 22 can be driven in the focusing direction F, the tracking direction T, and the tilting direction so as to obtain favorable servo-characteristics without complicated adjustment.

The optical disc apparatus 101 including the optical pickup device 1 can eliminate complicated adjustment for suppressing the natural frequency of the optical pickup device 1 without deteriorating servo-characteristics, so that the process is simplified and cost is reduced as well as favorable servo-characteristics can be obtained, thereby enabling an information signal to be satisfactorily recorded on/reproduced from an optical disc.

It should be understood by those skilled in the art that various modifications, combinations, sub-combinations and alterations may occur depending on design requirements and other factors insofar as they are within the scope of the appended claims or the equivalents thereof.

1. An optical pickup device comprising:
a lens holder comprising an objective lens focusing a light beam onto a signal recording surface of a rotated optical disc, the lens holder being movable in a focusing direction in parallel with the optical axis of the objective lens and in a tracking direction perpendicular to the optical axis of the objective lens;
a support body spaced from the lens holder in a tangential direction perpendicular to the focusing direction and to the tracking direction, the support body supporting the lens holder movably in the focusing direction and the tracking direction; and
an elastic support member supporting the support body to a base,
wherein the elastic support member includes a pair of support legs supporting the support body, the support legs being inclined to expand the space between the support legs from one ends supporting the support body toward the other fixed to the base, and
wherein a pair of the support legs respectively comprise a plurality of support pieces formed from the one ends toward the other and are respectively made of a plate-like member, a plurality of the support pieces being formed by forming roughly circular, roughly elliptic, or roughly rectangular cut-outs on the support legs.

2. The device according to claim 1, wherein a pair of the support legs are made of a plate-like member, respectively, and by forming the cut-outs on the support legs, a plurality of the support pieces are formed as well as flections are formed on each of the support pieces.

3. The device according to claim 1, wherein a pair of the support legs are made of a plate-like member, respectively, and by forming the cut-outs on the support legs, a plurality of the support pieces are formed as well as tongue pieces are formed to link only to any one of the one ends and the other.

4. The device according to claim 1, wherein a pair of the support legs are made of a plate-like member, respectively, and by forming the cut-outs on the support legs, a plurality of the support pieces are formed, and flections are formed on each of the support pieces, as well as tongue pieces are formed to link only to any one of the one ends and the other.

5. The device according to claim 3 or 4, wherein a damping material is applied to the tongue pieces.

6. The device according to claim 1, further comprising driving means applying a drive force to the support body, the drive force inclining the support body about the tangential axis so as to tilt the lens holder supported by the support body,
wherein the elastic support member supports the support body tiltably relative to the base.

7. The device according to claim 1, wherein a damping material is applied to between the support body and the base.

8. An optical pickup device comprising:
a lens holder comprising an objective lens focusing a light beam onto a signal recording surface of a rotated optical disc, the lens holder being movable in a focusing direction in parallel with the optical axis of the objective lens and in a tracking direction perpendicular to the optical axis of the objective lens;
a support body spaced from the lens holder in a tangential direction perpendicular to the focusing direction and to the tracking direction, the support body supporting the lens holder movably in the focusing direction and the tracking direction; and
an elastic support member supporting the support body to a base,
wherein the natural frequency of the elastic support member in modes of natural vibration in a rotational direction about the focusing axis, a rotational direction about the tracking axis, and a rotational direction about a tangential axis perpendicular to the focusing direction and to the tracking direction is larger than the rotation frequency of the optical disc as well as the natural frequency of the elastic support member is to be small to some extent of not impairing the servo-stability when the lens holder is displaced.

9. An optical disc apparatus comprising:
driving means for rotating an optical disc; and
an optical pickup device to irradiate the optical disc rotated by the driving means with a light beam so as to record or reproduce an information signal thereon or therefrom, the optical pickup device detecting a light beam reflected from the optical disc,
wherein the optical pickup device comprises
a lens holder comprising an objective lens focusing a light beam onto a signal recording surface of the rotated optical disc, the lens holder being movable in a focusing direction in parallel with the optical axis of the objective lens and in a tracking direction perpendicular to the optical axis of the objective lens;
a support body spaced from the lens holder in a tangential direction perpendicular to the focusing direction and to the tracking direction, the support body supporting the lens holder movably in the focusing direction and the tracking direction; and
an elastic support member supporting the support body to a base,
wherein the elastic support member includes a pair of support legs supporting the support body, the support legs being inclined to expand the space between the support legs from one ends supporting the support body toward the other fixed to the base, and
wherein a pair of the support legs respectively comprise a plurality of support pieces formed from the one ends toward the other and are respectively made of a plate-like member, a plurality of the support pieces being formed by forming roughly circular, roughly elliptic, or roughly rectangular cut-outs on the support legs.

10. An optical disc apparatus comprising:
driving means for rotating an optical disc; and
an optical pickup device to irradiate the optical disc rotated by the driving means with a light beam so as to record or reproduce an information signal thereon or therefrom, the optical pickup device detecting a light beam reflected from the optical disc,
wherein the optical pickup device comprises
a lens holder comprising an objective lens focusing a light beam onto a signal recording surface of the rotated optical disc, the lens holder being movable in a focusing direction in parallel with the optical axis of the objective lens and in a tracking direction perpendicular to the optical axis of the objective lens;
a support body spaced from the lens holder in a tangential direction perpendicular to the focusing direction and to the tracking direction, the support body supporting the lens holder movably in the focusing direction and the tracking direction; and
an elastic support member supporting the support body to a base,
wherein the natural frequency of the elastic support member in modes of natural vibration in a rotational direction about the focusing axis, a rotational direction about the tracking axis, and a rotational direction about a tangential axis perpendicular to the focusing direction and to the tracking direction is larger than the rotation frequency of the optical disc as well as the natural frequency of the elastic support member is to be small to some extent of not impairing the servo-stability when the lens holder is displaced.

11. An optical disc apparatus comprising:
a driving unit for rotating an optical disc; and
an optical pickup device to irradiate the optical disc rotated by the driving unit with a light beam so as to record or reproduce an information signal thereon or therefrom, the optical pickup device detecting a light beam reflected from the optical disc,
wherein the optical pickup device comprises
a lens holder comprising an objective lens focusing a light beam onto a signal recording surface of the rotated optical disc, the lens holder being movable in a focusing direction in parallel with the optical axis of the objective lens and in a tracking direction perpendicular to the optical axis of the objective lens;
a support body spaced from the lens holder in a tangential direction perpendicular to the focusing direction and to the tracking direction, the support body supporting the lens holder movably in the focusing direction and the tracking direction; and
an elastic support member supporting the support body to a base,
wherein the elastic support member comprises a pair of support legs supporting the support body, the support legs being inclined to expand the space between the support legs from one ends supporting the support body toward the other fixed to the base, and
wherein a pair of the support legs respectively comprise a plurality of support pieces formed from the one ends toward the other and are respectively made of a plate-like member, a plurality of the support pieces being formed by forming roughly circular, roughly elliptic, or roughly rectangular cut-outs on the support legs.

12. An optical disc apparatus comprising:
a driving unit to rotate an optical disc; and
an optical pickup device to irradiate the optical disc rotated by the driving unit with a light beam so as to record or reproduce an information signal thereon or therefrom, the optical pickup device detecting a light beam reflected from the optical disc,
wherein the optical pickup device comprises
a lens holder comprising an objective lens focusing a light beam onto a signal recording surface of the rotated optical disc, the lens holder being movable in a focusing direction in parallel with the optical axis of the objective lens and in a tracking direction perpendicular to the optical axis of the objective lens;
a support body spaced from the lens holder in a tangential direction perpendicular to the focusing direction and to the tracking direction, the support body supporting the lens holder movably in the focusing direction and the tracking direction; and
an elastic support member supporting the support body to a base,
wherein the natural frequency of the elastic support member in modes of natural vibration in a rotational direction about the focusing axis, a rotational direction about the tracking axis, and a rotational direction about a tangential axis perpendicular to the focusing direction and to the tracking direction is larger than the rotation frequency of the optical disc as well as the natural frequency of the elastic support member is to be small to some extent of not impairing the servo-stability when the lens holder is displaced.
